(19) United States
(12) Patent Application Publication
(10) Pub. No.: US 2018/0037340 A1
(43) Pub. Date: Feb. 8, 2018

(54) SATELLITE MANAGEMENT SYSTEM COMPRISING A PROPULSION SYSTEM HAVING INDIVIDUALLY SELECTABLE MOTORS

(71) Applicant: Pacific Scientific Energetic Materials Company, Valencia, CA (US)

(72) Inventors: Steven NELSON, Huntington Beach, CA (US); Richard HENDERSON, Salinas, CA (US); Bret OMSBERG, San Jose, CA (US)

(21) Appl. No.: 15/784,823

(22) Filed: Oct. 16, 2017

Related U.S. Application Data
(63) Continuation-in-part of application No. 14/844,597, filed on Sep. 3, 2015, now Pat. No. 9,790,895.
(60) Provisional application No. 62/045,493, filed on Sep. 3, 2014.

(51) Int. Cl. B64G 1/10; G08G 5/00; F02K 9/10; B64G 3/00

(52) U.S. Cl. CPC B64G 1/1014; B64G 3/00; G08G 5/0047; G08G 5/0095; F02K 9/10

(57) ABSTRACT

A control system for a satellite comprises a power source and control system, a propulsion system having individually selectable solid fuel motors, a communication interface and an attitude determination and control system (ADCS). The ADCS receives power from the power source and control system and further receives desired orbital or positional instructions via the communication interface. Based on the desired orbital or position instructions, the ADCS generates and provides commands to the propulsion system. In turn, the propulsion system selects and fires one or more motors of the individually selectable solid fuel motors responsive to the commands received from the ADCS. A satellite may comprise the disclosed satellite control system as well as attitude control components and/or sensor components operatively connected to the satellite control system.

### CROSS-REFERENCE TO RELATED APPLICATION

The instant application is a continuation-in-part of U.S. patent application Ser. No. 14/844,597 entitled “PROPULSION SYSTEM COMPRISING PLURALITY OF INDIVIDUALLY SELECTABLE SOLID FUEL MOTORS” and filed Sep. 3, 2015, which prior application claims the benefit of Provisional U.S. Patent Application Ser. No. 62/045,493 entitled “SOLID STATE PROPULSION AND ATTITUDE CONTROL SYSTEM FOR SATELLITES” and filed Sep. 3, 2014, the teachings of which are incorporated herein by this reference.

### FIELD

The instant disclosure relates generally to satellites, and, more particularly, to a satellite control system comprising a propulsion system having a plurality of individually selectable solid fuel motors.

### BACKGROUND

Artificial satellites have long been in use for space or earth observation, reconnaissance, navigation, communications and scientific measurements. Satellites typically consist of a mission payload and a payload platform or bus. The mission payload performs one or more of the aforementioned functions and the payload platform provides electrical power, thermal management, payload pointing, terrestrial communications, and attitude and orbit control to support the mission payload. Electrical power is typically supplied using solar cells and batteries for power storage and supply when the satellite is in earth's shadow. Thermal management may include heaters when in the earth's shadow, and payload pointing and reflective materials to avoid solar heating. Communications takes place using an omnidirectional antenna between the satellite and ground stations for state of health telemetry, command and control. Finally, most satellites include an attitude determination and control system (ADCS) consisting of sensors and momentum wheels for keeping the satellite pointed in the correct direction and removing residual momentum. In addition to the ADCS, many satellites include an on-board propulsion system for maneuvering and positioning the satellite.

Existing choices for satellite propulsion include monopropellant and bipropellant liquid propellants, cold gas propellants and electric propulsion. Unfortunately, most satellite propulsion systems have significant disadvantages. For example, liquid propellants are frequently toxic, require complex plumbing, valving and pressurization systems and, when firing rocket motors, consume significant power. Cold gas systems, while less complex than liquid propellant systems also require plumbing and valving, have poor mass and delivered impulse efficiency and also require significant power when firing motors. Electric propulsion systems have very high impulse efficiency, but are heavy and typically require very high power levels to operate and produce very low thrust levels.

Thus, it would be advantageous to provide a propulsion system that overcomes many of the above-noted deficiencies.

### SUMMARY

The instant disclosure describes a management system for a satellite comprising a power source, a propulsion system comprising individually selectable solid fuel motors, a communication interface and an attitude determination and control system (ADCS). The ADCS receives power from the power source and further receives desired orbital or positional instructions via the communication interface, which may comprise a wireless communication interface. Based on the desired orbital or position instructions, the ADCS generates and provides commands to the propulsion system. In turn, the propulsion system selects and fires one or more motors of the individually selectable solid fuel motors responsive to the commands received from the ADCS. In an embodiment, the propulsion system comprises a substrate, a communication network and a cluster of individually selectable solid fuel motors mounted on the substrate and operatively connected to the communication network. The propulsion system further comprises a controller that is also operatively connected to the communication network and operative to select any one of more motors of the cluster of individually selectable solid fuel motors and transmit signals to fire the one or more motors of the individually selectable solid fuel motors based on the commands. In another embodiment, a satellite may comprise a satellite management system in accordance with the instant disclosure. In addition to the satellite management system, a satellite may further comprise attitude control components and/or sensor components operatively connected to the satellite management system.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is a schematic block diagram of a propulsion system in accordance with the instant disclosure;

FIG. 2 illustrates a partial cross-sectional view of a one embodiment of a substrate and a cluster of solid fuel motors in accordance with the instant disclosure;

FIG. 3 illustrates perspective view of another embodiment of a substrate and a cluster of solid fuel motors in accordance with the instant disclosure;

FIG. 4 illustrates a perspective view of the propulsion system of FIG. 3 mounted within a deployment pod;

FIG. 5 is a cross-sectional view of a solid fuel motor in accordance with the instant disclosure; and

FIG. 6 is a schematic block diagram of a first embodiment of a satellite incorporating a pair of propulsion systems in accordance with the instant disclosure.

FIG. 7 is s schematic block diagram of a second embodiment of a satellite incorporating a satellite management system in accordance with the instant disclosure.

### DETAILED DESCRIPTION OF THE PRESENT EMBODIMENTS

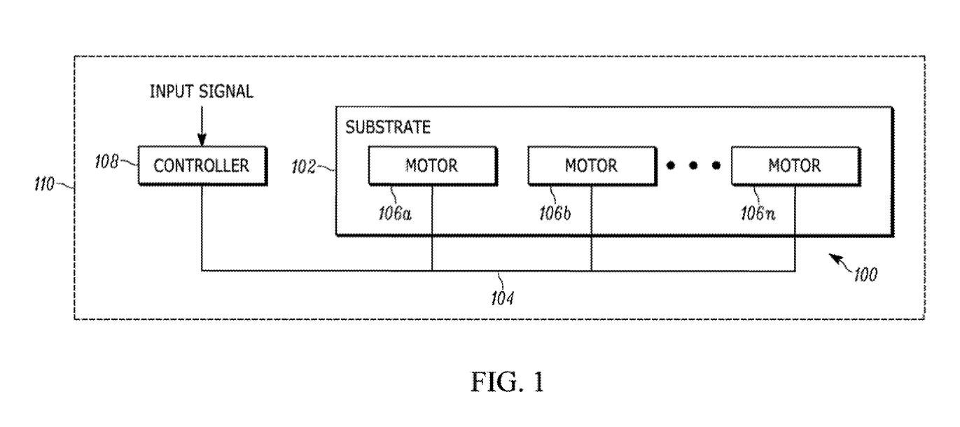

Referring now to FIG. 1, a propulsion system 100 in accordance with the instant disclosure is illustrated. In particular, the propulsion system 100 comprises a substrate or housing 102 having a cluster of solid fuel motors 106 mounted on the substrate 102. As used herein, a cluster constitutes a group of same or similar items gathered or occurring closely together. Thus, as illustrated in further embodiments described below, the motors 106 are grouped together with relatively little space between them in order to minimize the overall size of the propulsion system 100. A controller 108 is operatively connected to each of the motors 106 via a communication network 104. A feature of the instant disclosure is that each of the motors 106 is individually selectable or addressable by the controller 108. As further shown, the propulsion system 100 may constitute a component of a satellite 110. The nature and construction of the satellite 110 is not limited to any particular types, though, as described in further detail below, the beneficial application of the propulsion system 100 to the satellite 110 may depend on the size of the satellite 110.

In an embodiment, the controller 108 and communication network 104 may be implemented using a Smart Energetics Architecture (SEA™) bus as provided by Pacific Scientific Energetic Materials Company of Hollister, Calif., and described, for example, in U.S. Pat. No. 7,644,661, the teachings of which prior patent are incorporated herein by this reference. As known in the art, the controller 108, as implemented in the SEA bus, can select any one of the individual motors 106 and transmit signals to the selected motor to, among other things, cause that motor to fire. For example, as shown in FIG. 1, the controller 108 could send a signal to only the first motor 106a of the n different motors. In an embodiment, the number of motors, n, mounted on the substrate 102 may typically number from 10 to 1000 individually addressable motors. In practice, the number of motors used will depend largely upon the nature of the particular application. As used herein, it is understood that the controller 108 may include components that are specific to, and collocated with, respective ones of the motors 106. For example, in the SEA bus implementation, the controller 108 may comprise a centralized, network controller (implemented as an application specific circuit (ASIC), microprocessor, microcontroller, programmable logic array (PLA), etc.) that communicate with integrated circuits deployed in connection with each of the motors 106. Because each of the integrated circuits includes a unique identifier stored therein, the network controller can effectively select any individual motor 106. Generally, the SEA bus is a flight-proven, very low volume and power, multiple-inhibit, space radiation tolerant, ASIC-based control and firing system. In practice, the SEA bus enables firing of hundreds of motors with microsecond repeatability and sub-millisecond sequencing. As indicated by the input signal provided to the controller 108, the SEA bus is capable of interfacing with a satellite control system via an RS-422 compliant serial bus or other parallel or serial interface options as known in the art.

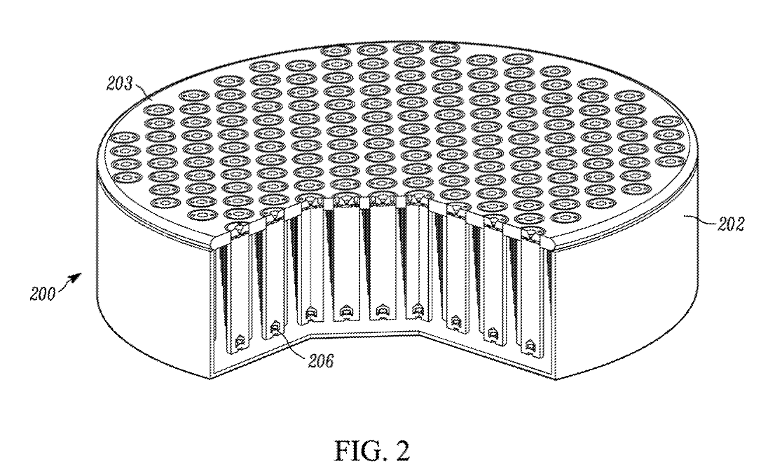

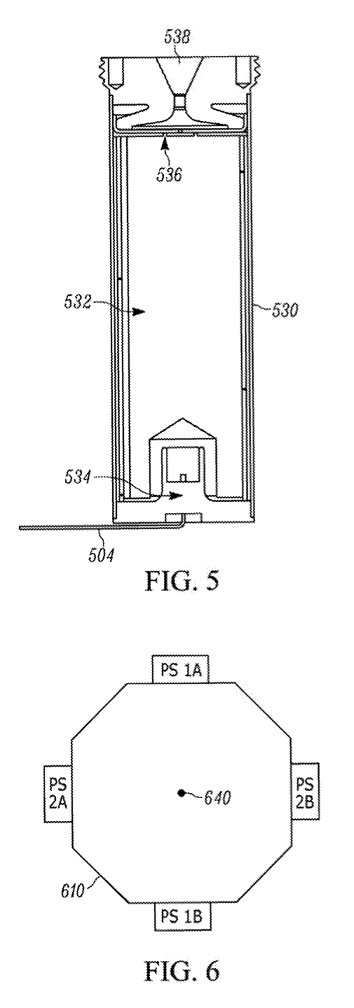

Referring now FIG. 2, an exemplary propulsion system 200 is illustrated. In particular, the system 200 comprises a substrate 202 having a substantially (i.e., within manufacturing tolerances) circular perimeter and planar upper surface 203, as shown. The substrate 202 may be manufactured out of any suitable material such as aluminum, steel, titanium, etc., or a non-outgassing space rated plastic/polymer as known in the art. Each motor 206 is mounted such that its nozzle (see FIG. 5) is substantially flush with the upper surface 203. Though the substrate 202 is illustrated having an essentially planar surface 203, this is not a requirement and the surface 203 may be curved as in the case of a cylindrical, hemispherical or other curved shaped. Further still, the upper surface 203 may comprise multiple planar surfaces. As further illustrated in FIG. 2, though not a requirement, the cluster of motors 206 is arranged in an array, i.e., according to regular columns and rows.

FIG. 5 illustrates an example of a solid fuel motor 506 shown in cross section. As shown, the motor 506 comprises a tubular housing 530 encasing a solid propellant 532. The tubular housing 530 may be fabricated from any suitable metal such as aluminum, steel or titanium. Preferably, the solid propellant 532 is “green” in that it is free of (or at least minimizes) any metals and is smokeless, and may comprise a single or double base or a composite material. The propellant 532 is hermetically sealed within the housing 530 by an igniter 534 on one end and a burst disk 536 on the other end. The igniter 534 may comprise any suitable igniter as known in the art, including but limited to, including an exploding foil initiator (EFI), a semiconductor bridge (SCB), reactive semiconductor bridge (RSCB), thin film bridge (TFB) or a bridgewire initiator. As shown, the igniter 534 is coupled to a signal path 504 that carries an electrical signal (initiated, for example, in response to a control signal provided by the controller 108 of FIG. 1) capable of firing the ignitor 534. The burst disk 536 is preferably petaled so as to minimize any debris upon ignition. As further shown and known in the art, the motor 506 may also comprise a nozzle plate 538 to beneficially guide the combustion products provided by the propellant 532. In an embodiment, each motor 506 is dimensioned to carry 14 g of propellant 532, and has an overall mass of approximately 20 g. Thus configured, each motor 534 provides 27.4 N-s of impulse upon ignition.

Referring once again to FIG. 2, in the illustrated embodiment, the substrate 202 is 15 inches in diameter and 5 inches tall, though these dimensions may vary as a matter of design choice. As configured, and assuming motors 206 in accordance with the embodiment of FIG. 5, the substrate 202 and cluster of motors 206 fits within a separation system volume of a typical satellite and provides 5500 N-s total impulse or 55 m/s delta-V (i.e., the impulse available to perform a desired maneuver of a satellite) on a 100 kg spacecraft. Although the substrate 202 in FIG. 2 is shown mounted with approximately 80 motors, it is once again understood that the substrate 202 may include tens or hundreds of such individual motors. Additionally, while the motors 206 illustrated in FIG. 2 are all of the same size, and therefore possess the same impulse capability, it is understood that this is not a requirement. That is, the cluster of motors may include subsets of motors, where the motors of each subset are of the same size/impulse capability, yet different in size/impulse capability than the motors of each of the other subsets.

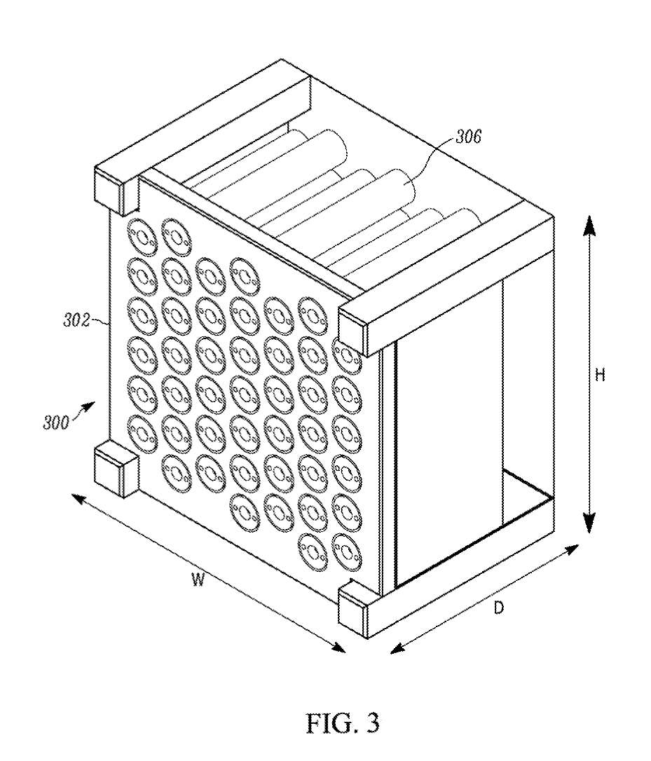

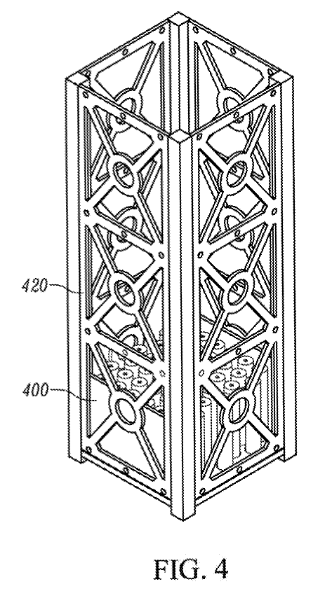

Referring now to FIG. 3 an alternate embodiment of a propulsion system 300 in accordance with the instant disclosure is illustrated. In this embodiment, the substrate 302 is once again planar and has a substantially rectangular outer perimeter. In keeping with the so-called CubeSat reference design standard. As known in the art, the CubeSat design standard requires modules that fit within a 10 cm×10 cm×10 cm cube, often referred to as “one unit” or “1U” module. Thus, in the embodiment illustrated in FIG. 3, the height (H) and width (W) dimensions of the substrate 302 are selected to be 10 cm each and the depth (D) dimension is selected to be 5 cm, thus forming what is typically referred to as “½U” configuration. Additionally, so-called ¼U or “tuna can” configurations are also possible. It noted that the motors 306 in FIG. 3, while clustered as in FIG. 2, are not arranged in the column and rows of a rectangular array, but are instead arranged in diagonal rows of differing lengths. As shown in FIG. 4, the propulsion system 300 of FIG. 3 may be mounted within a so-called 3U deployment pod 420. Assuming compliance with the CubeSat standard and use of the motors 504 described above relative to FIG. 5, the propulsion system 300 can provide approximately 40 m/s delta-V for a 3U CubeSat.

With reference to FIG. 6, an exemplary satellite 610 may comprise pairwise deployments of propulsion systems in accordance with the instant disclosure. More particularly, each pair of propulsion systems may be mounted on the satellite 610 in complementary positions about a center of gravity 640 of the satellite 610. For example, a first pair of propulsion systems, PS 1A and PS 1B, may be configured to induce clockwise rotation of the satellite 610 about the center of gravity 640, whereas a second pair of propulsion systems, PS 2A and PS 2B, may be configured to induce counter-clockwise rotation of the satellite 610 about the center of gravity. Those of skill in the art will appreciate that other pairwise deployments of propulsion systems in other rotational planes may be additionally deployed on the satellite 610. Alternatively, the pairs of propulsion systems PS 1A, PS 1B, PS 2A, PS 2B may be configured such that opposing motors can be actuated to induce strictly linear translation of the satellite 610. Further still, a single “plate” of motors may also be mounted on an axis intersecting the center of gravity 640 with opposing motor pairs actuated for pure linear translation along the axis.

In this manner, propulsion systems in accordance with the instant disclosure may be used in addition to or as part of the ADCS (not shown), or linear propulsion system, of the satellite 610. That is, such propulsion systems, in addition to performing delta-V maneuvers for station keeping, can also perform pointing or attitude control maneuvers. A particular advantage of the presently described propulsion systems is that, by enabling such attitude control capability, satellite operators are able to use lower power momentum wheels and perform “momentum dump” maneuvers. Additionally, since motors are can be fired in pairs around the satellite center of gravity 640, the random, very small variations in motor impulse result in lower overall residual spacecraft momentum compared to prior art, liquid propulsion systems, once again resulting in less momentum wheel use and energy consumption.

Furthermore, use of as SEA bus as described above enables reduction of satellite power requirements and solar panel size. The lack of ancillary hardware of the instant propulsion systems as compared to liquid propellant systems, such as propellant and pressurant tanks, valves, plumbing, and fittings, greatly reduces the package volume of the propulsion systems. Additionally, due to the modular and flexible design of the instant propulsion systems, they are easily adaptable to fit in unused space within satellite structures including separation rings, mounting areas for star trackers, seekers, solar arrays, etc. Further still, the construction of propulsion systems in accordance with the instant disclosure result in a very favorable shipping classification and the “bolt on” nature of a solid propulsion system is possible, thereby greatly reducing life cycle costs due to ease of handling, workflow simplification and design simplicity.

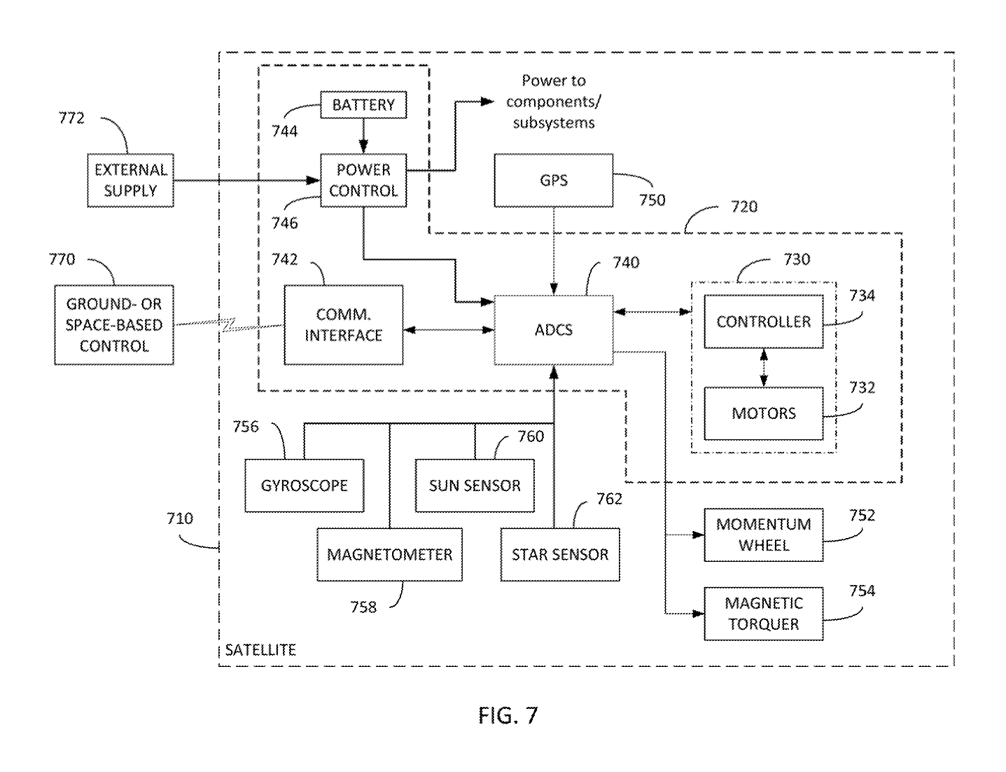

Referring now to FIG. 7, a second embodiment of a satellite 710 is illustrated. In this embodiment, the satellite 710 includes a management system 720 that, in turn, includes a propulsion system 730 in accordance with the various propulsion systems described above. In particular, the propulsion system 730 includes a controller 734 that communicates with a plurality of individually selectable solid fuel motors 732 as described above. As further shown, the management system 720 further comprises an attitude determination and control system (ADCS) 740, a communication interface 742 and a power source that includes a battery 744 and a power controller 746. The battery 744, which may comprise, for example, a radioisotope thermoelectric generator (RTG) as known in the art, provides electrical power that is controlled and distributed by the power controller 746 to not only the ADCS 740, but all other components in the satellite 710 requiring electrical power. Optionally, rather than receiving power only from the battery 744, an external power supply 772 may be used with the power controller 746. For example, the external power supply 772 may comprise additional known batteries or fuel cells. Alternatively, or additionally, the external supply 772 could take the form of one or more solar cells or solar panels. Furthermore, as known in the art, the power controller 746 may comprise various components used to condition power provided by the battery 744 and/or external supply 772 including but not limited to linear regulators, DC-DC converters, analog dividers, transient voltage suppression (TVS) diodes, combinations thereof, etc.

As shown, the satellite 710 may comprise one or more attitude control components including, but not necessarily limited to, one or more momentum wheels 752 and/or one or more magnetic torquers 754. As known in the art, such components may be used to adjust the orbit or attitude of the satellite 710 as needed. As further shown, the satellite 710 may comprise one or more sensor components including, but not necessarily limited to, a Global Positioning System (GPS) receiver 750, one or more gyroscopes 756, one or more magnetometers 758, a sun sensor 760 and/or a star sensor 762. As known in the art, such components may be used to determine the actual location and/or attitude of the satellite 710 at any given time. Through use of these components 730, 750-762, the ADCS 740 may effectuate any desired corrections or adjustments to the orbit and/or attitude of the satellite 710.

As known in the art, the ADCS 740 may comprise one or more computing devices (such as, but not limited to, a microprocessor, microcontroller, digital signal processor, application specific circuit, programmable logic array, etc.) and other related components (e.g., memory, peripheral interfaces, etc.). The ADCS 740 is configured to receive desired orbital or positional (attitude) instructions via the communication interface 742. In an embodiment, the communication interface 742 may comprise a wireless communication interface capable of operation at various radio frequencies and using various well-known communication protocols. As shown, the communication interface 742 may receive the desired orbital or positional instructions via a ground- or space-based controller 770 capable of transmitting such instructions to the satellite 710, as known in the art. Based on these received instructions, and using known techniques, the ADCS 740 determines commands that may be used to control operation of the propulsion system 730 and/or other attitude control components 752, 754 to effectuate the desired orbital or positional instructions. For example, if it is desired to adjust the rotation of the satellite 710 about a given axis (and assuming appropriate configuration of the motors 732) by a certain number of degrees, this change can be transmitted to the satellite 710 and provided, via the communication interface 742 to the ADCS 740. In turn, the ADCS 740, having stored knowledge of the motors 372, such as availability (i.e., which motors have and have not been previously fired), configuration (i.e., the direction of the force vector that could be applied to the satellite by a given motor) and properties (e.g., the impulse of any given, available motor), provides commands to the propulsion system 730 (specifically, the controller 734) to select and fire one or more of the motors 732 to effectuate the desired change. Such knowledge may be stored in suitable memory or the like used to implement the ADCS 740 and updated as the status of individual motors changes. Using appropriate feedback (as provided, for example, by the various sensors 756-762), the ADCS 740 can assess the effect of the provided commands to determine whether further commands are necessary to properly effectuate the received instructions.

As a specific example, the communication interface 742 may receive a suitably encoded transmission embodying an instruction to “translate the spacecraft linearly in the x-direction by 10 m/s for 1.5 seconds.” This instruction is passed to the ADCS 740 and, based on its stored knowledge of the motors 732 and using known algorithms to translate the capabilities of the motors 732 into the desired performance, the ADCS 740 determines one or more commands that can be provided to the controller 734 in order to actuate the necessary motors 732 and/or check sensor measurements for feedback. Suitable algorithms for this purpose may be found, for example, in “Fundamentals of Spacecraft Attitude Determination and Control,” F. L. Markley et al., Springer Science+Business Media (2014) or “Space Mission Engineering: The New SMAD,” edited by J. R. Wirtz et al., Microcosm Press (2011).

For example, in light of the received instruction described above, the ADCS 740 can determine that motors labeled 2, 4, 6 and 8 in a first array of motors should be fired at a specific time (i.e., at t=0 ms) to initiate the desired translation. In addition to the issuance of those commands, the ADCS 740 can check sensor inputs to determine if any further commands are necessary, or the ADCS 740 can continue with issuing further commands. Continuing with the current example, after the commands to fire motors 2, 4, 6 and 8 in the first array have been issued, the ADCS 740 can check sensor inputs (e.g., one or more accelerometers) to assess whether recalculations and further commands are needed. That is, the ADCS 740 can incorporate feedback into its determination of commands necessary to effectuate the received instructions. Alternatively, the ADCS 740 can simply proceed with issuing further commands, e.g., fire motors 3, 9 and 12 in the first array after a delay of 0.5 ms (at t=0.5 ms), notwithstanding any intervening sensor measurements. As known in the art, such commands can be embodied by the ADCS 740 in a matrix form, as illustrated in Table 1 below.

TABLE 1

| | | Time | | | |
|---|---|---|---|---|---|
| Seq. # | Command | (ms) | Array | Device | Group |
| 1 | Fire | t = 0 | 1 | 0 | 0 |
| 2 | Status | t = 0.1 | 1 | 0 | 0 |
| 3 | Fire | t = 0 | 1 | 0 | 1 |
| 4 | Status | t = 0.1 | 1 | 0 | 1 |
| 5 | Fire | t = 1 | 1 | 1 | 1 |
| 6 | Fire | t = 1 | 1 | 1 | 2 |
| 7 | Fire | t = 1 | 1 | 1 | 3 |
| 8 | Fire | t = 1 | 1 | 1 | 4 |

In the example of Table 1, the ADCS 740 can create simultaneous commands such as firing motor 0 in array 1/group 0 at the same time as firing motor 0 in array 1/group 1 at t=0 (sequence numbers 1 and 3) or firing motors 1-4 in array 1/group 1 at t=1 ms (sequence numbers 5-8). Additionally, opportunities for adjustments may be provided by assessing status, e.g., checking status of motor 0/array 1/group 0 and motor 0/array 1/group 1 at t=0.1 ms (sequence numbers 2 and 4). It is noted that, although the examples above concern commands issued by the ADCS 740 relative to the motors 732 of the propulsion system 730, such command may also be used to actuate attitude control components 750, 752 as well. Furthermore, as noted above, having caused individual ones of the motors 732 to be fired, the ADCS 740 can update its stored knowledge of the motors, e.g., update the status of which motors remain available after completion of the issued commands.

While particular preferred embodiments have been shown and described, those skilled in the art will appreciate that changes and modifications may be made without departing from the instant teachings. It is therefore contemplated that any and all modifications, variations or equivalents of the above-described teachings fall within the scope of the basic underlying principles disclosed above and claimed herein.

What is claimed is:

1. A management system for a satellite, comprising:
a power source;
a propulsion system comprising individually selectable solid fuel motors;
a communication interface; and
an attitude determination and control system (ADCS), operatively connected to the communication interface and the propulsion system and configured to receive power from the power source, the ADCS operative to receive desired orbital or positional instructions via the communication interface and provide commands to the propulsion system based on the desired orbital or positional instructions, wherein the commands cause the propulsion system to select and fire one or more motors of the individually selectable solid fuel motors.

2. The management system of claim 1, wherein the propulsion system further comprises:
a substrate;
a communication network;
a cluster of individually selectable solid fuel motors mounted on the substrate and operatively connected to the communication network; and
a controller, operatively connected to the communication network and operative to select any one or more motors of the individually selectable solid fuel motors and, responsive to at least some of the commands, transmit signals to fire the one or more motors of the individually selectable solid fuel motors.

3. The management system of claim 1, wherein the communication interface comprises a radio frequency receiver.

4. The management system of claim 1, wherein the power source comprises a radioisotope thermoelectric generator.

5. The management system of claim 1, wherein the power source comprises a solar cell.

6. A satellite comprising the management system of claim 1.

7. The satellite of claim 4, further comprising at least one attitude control component operatively connected to the ADCS, where the at least one attitude control component comprises any of a momentum wheel or magnetic torquer.

8. The satellite of claim 7, wherein the ADCS is further operative to provide commands to the at least one attitude control component.

9. The satellite of claim 4, further comprising at least one sensor component operatively connected to the ADCS, wherein the at least one sensor component comprises any of a gyroscope, a magnetometer, a sun sensor or a star sensor.

10. The satellite of claim 9, wherein the ADCS is further operative to receive inputs from the at least one sensor component.

11. A method for managing a satellite having an attitude determination and control system (ADCS), the method comprising:
receiving, by the ADCS via a communication interface, desired orbital or positional instructions; and
providing, by the ADCS, commands to a propulsion system having individually selectable solid fuel motors, the commands based on the desired orbital or positional instructions, wherein the commands cause the propulsion system to select and fire one or more motors of the individually selectable solid fuel motors.

12. The method of claim 11, wherein the commands cause the propulsion system to simultaneous fire two or more motors of the individually selectable solid fuel motors.

13. The method of claim 11, wherein providing the command to the propulsion system further comprises:
receiving, by the ADCS, inputs from at least one sensor component; and
determining, by the ADCS, the commands based on the inputs from the at least one sensor component.

14. The method of claim 11, wherein providing the command to the propulsion system further comprises:
determining, by the ADCS, the commands based on stored knowledge of the individually selectable solid fuel motors.

15. The method of claim 14, wherein the stored knowledge includes availability of the individually selectable solid fuel motors, configuration of the individually selectable solid fuel motors and properties of the individually selectable solid fuel motors.

16. The method of claim 14, further comprising:
updating, by the ACDS, the stored knowledge of the individually selectable solid fuel motors based on the commands.
